(19) United States
(12) Patent Application Publication
(10) Pub. No.: US 2020/0294102 A1
(43) Pub. Date: Sep. 17, 2020

(54) REVIEWS, RATINGS AND FEEDBACKS SYSTEM AND METHOD

(71) Applicant: Jagadish konduru Srinivasa, Charlotte, NC (US)

(72) Inventor: Jagadish konduru Srinivasa, Charlotte, NC (US)

(21) Appl. No.: 16/351,572

(22) Filed: Mar. 13, 2019

(51) Int. Cl. G06Q 30/02

(52) U.S. Cl. CPC G06Q 30/0282; G06T 11/206

(57) ABSTRACT

A system and method for collecting and generating reviews, ratings and feedbacks from users is provided. In the disclosure, the system includes a platform for collecting and generating reviews, ratings and feedbacks in form of multi-dimensional graph/charts/dashboards. The reviews, the ratings and the feedbacks are received from users based on predefined various parameters of a product/service/facility.

### FIELD OF THE INVENTION

The present invention relates generally to a system and method for collecting and generating reviews, ratings and feedbacks from users to products, services and facilities etc. More particularly, the present invention provides a system and a method for collecting and generating reviews, ratings and feedbacks from users in form of multi-dimensional graph/charts/dashboards based on various key parameters.

### BACKGROUND OF THE INVENTION

Generally, ratings, reviews and feedbacks are used to predict whether the products, services and facilities etc. will be right for the users/consumers/customers based on the experience. The ratings, reviews and feedbacks are collected via offline and online surveys from different users. In last decade, there is substantial growth of internet users and use of mobile phones specifically smart phones, the users spend more time in searching anything on internet. Further, people are more dependent on the internet to find the products, services and facilities etc. and make decision based on the ratings, reviews and feedbacks. It is a human tendency that they are more interested in which have positive reviews.

There are many systems available for providing ratings, reviews and feedbacks such for example movies are reviewed using a film-rating system to rate a movie's suitability for certain audiences, helping them to make the decision whether to watch or not. Similarly, television shows and video games have ratings to help parents determine if the content is suitable for their children and to help consumers determine if the content is right for them.

Further, the feedback system in form of customer feedback is collected and provided for the purpose of improving services, food, entertainment, products, or other product or services to attract new customers. Even polls are conducted based on some parameters.

These systems are for providing feedback based on number of stars and writing reviews, which are obsolete and may be tedious for both who is rating and reviewing/providing feedback and also for the one who is evaluating/reading the ratings/reviews/feedbacks.

In most cases, the users just rate their experience related to a product or service or facility or location or application but will not write a review because of lack of time or other obvious reasons.

One main problem with the current system is one dimensional which means by looking at number of ratings doesn't give the exact details whether the experience (with products or services or facilities) quality is good, whether experience is worth its value, whether the service is good or not etc. based on various parameters of user choices.

Further, these systems are generally common to all products, services, facilities locations. It can't be defined based on parameters how the user can provide a feedback.

Therefore, at present with availability of touch screens, Natural Language Processing, Artificial Intelligence, Internet of Things, Augmented reality and Virtual reality, there is a need for a multi-dimensional system for ratings, reviews and feedbacks where a user should be able to provide his/her rating or review or feedback on but not limited to products, services and facilities, movies, foods and restaurants etc based on various parameter already defined and can be represented in the form of a Graph/a Chart/a Dashboard for ease of convenience.

### SUMMARY OF THE INVENTION

The present invention provides a system and method for collecting and generating reviews, ratings and feedbacks from users in a quick and easy to use format. The reviews, the ratings and the feedbacks are received based on various parameters of a product/service in form of multi-dimensional configuration such as but not limited to a graph, a chart, a dashboard.

In one aspect of the present invention is to provide a system and method that can intelligently differentiate the user review, rating and feedback based on various parameters.

In one aspect of the present invention is to provide a system and method that significantly decreases the time of user for providing reviews, ratings and the feedbacks on a product/service and as well as reading the same.

In one aspect of the present invention, the system eliminates the need of writing and reading long reviews.

In one aspect of the present invention, the reviews are based on predefined parameters for reviews, ratings and feedbacks.

In one aspect of the present invention, a system includes an interface for collecting and generating the reviews, the ratings and the feedbacks from users. The interface is configured with a rating module to provide the user with one or more parameters representing attributes of a product and/or service, then receiving the reviews, the ratings and the feedbacks from the users and representing in form of but not limited to a chart summary, a text summary, an audio summary, a video summary, an augmented summary and a virtual Summary.

In one aspect of the present invention, the system is configured for collecting and generating reviews, ratings and feedbacks from users based on various parameter of the product/service, wherein the parameters representing attributes of a product and/or service is represented on X-axis and the reviews, the ratings and the feedbacks form the user is obtained on each parameter is represented by a numeric scale on Y-axis.

In one aspect of the present invention, the reviews, the ratings and the feedbacks are represented on the interface in form of but not limited to a line graph, a bar graph and a multi-dimensional graph.

In one aspect of the present invention, the system further includes a text module to retrieve the reviews, the ratings and the feedbacks in form of a text from the users.

In one aspect of the present invention, the system further includes an audio module to retrieve the reviews, the ratings and the feedbacks in form of an audio-based that is the recorded directly from user's speech.

In one aspect of the present invention, the system further includes a video module to retrieve the reviews, the ratings and the feedbacks in form of video recording data that is captured from user's body language and facial expressions or combination thereof.

In another aspect of the present invention provides a computer-implemented method of collecting and generating reviews, ratings and feedbacks from users. The method includes receiving a set of parameters from at least one user (service provider or product owner or facility, etc.), each parameter including a topic of information relating to different aspects features and qualities, receiving hits on the set of parameters by the users, performing a computation of each of the received hits on the set of parameters; and generating a continuous multi-dimensional feedback in the form of graph/charts/dashboards according to change in number of hits on different set of parameters, and transmitting the feedback, over the network, in substantially real-time.

One advantage of the present invention, the step of transmitting the feedback in substantially real-time enables service provider or product owner or facility, etc. a corrective action recommendation responsive to receiving hits on the set of parameters by the different users.

In another advantage of the present invention, the system and method provide more meaningful reviews, ratings and feedbacks; because the content (products/services/facilities) can be rated on a wide variety of parameter, enabling the system to better predict the recommendation to the users. The meaningful reviews, ratings and feedbacks are useful to the user rating the content, other users, and owners seeking to improve their services/product/facility/etc.

In another advantage of the present invention, the system and method provided herein is simpler than other systems known to the person skilled in the art. Because the system does not require a user to prepare a comment or answer a long series of questions in order to classify the reviews, ratings and feedbacks on a service/product.

In another advantage of the present invention, the system and method provide provisions that can record the feedback directly from user's speech and derive proper analytics in a way of saving customers' time and capturing a greater number of feedbacks.

In another advantage of the present invention, the system and method provide provisions that can capture customer's body language, facial expressions and other aspects of customer's experience feedback silently and get user's input to generate a feedback.

These and other aspects are discussed in detail below. The foregoing information and the following detailed description include illustrative examples of various aspects and implementations and provide an overview for understanding the claimed aspects and implementations.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows a review system of the present invention in accordance with an embodiment of the present invention;

FIG. 2 shows an exemplary representation of the reviews in different format in accordance with an embodiment of the present invention;

FIG. 3 shows a method for collection and representation of reviews from users in accordance with an embodiment of the present invention;

FIG. 4a shows an interface of a review system in accordance with an embodiment of the present invention;

FIG. 4b shows a computed review in line form in accordance with an embodiment of the present invention;

FIG. 5a shows an exemplary review method in accordance with an embodiment of the present invention;

FIG. 5b shows an exemplary review received from the users in form of a line representation in accordance with an embodiment of the present invention;

FIG. 5c shows an exemplary review received from the users in graphical form in accordance with an embodiment of the present invention;

FIG. 6 shows another exemplary method in accordance with an embodiment of the present invention; and

FIG. 7 shows continuous multi-dimensional feedback in accordance with an embodiment of the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

It should be understood that the term “review” as mentioned herein generally refers to any information pertaining to feedback, rating, observation, experience related to the users. The term “user or users” generally refers to reviewer or review reader or consumer or a customer.

In the present disclosure the term “review” can be used interchangeably with the “feedback” and/or “rating”.

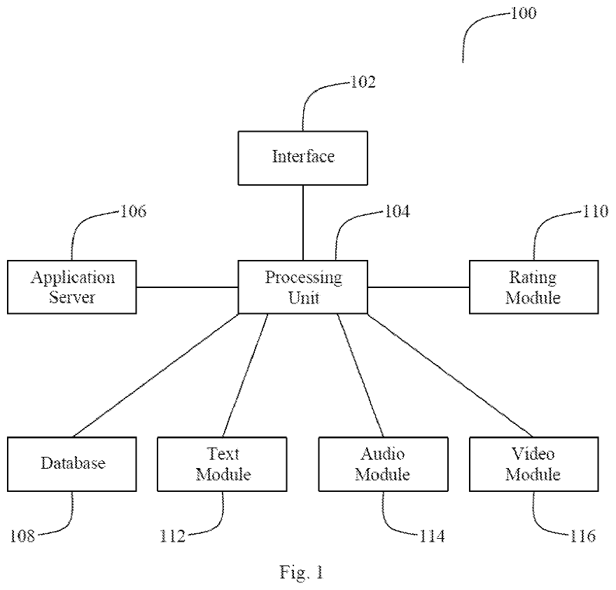

FIG. 1 illustrates a system 100 for collection and thereafter collative representation of reviews, ratings and feedbacks from users. The system 100 may be software, hardware or a combination thereof embodied in a mobile Smartphone, a personal digital assistant, a computer, and the like. In an embodiment of the present invention, the system may be a software application or a plug-in software application.

As shown in FIG. 1, the system 100 includes an interface 102, a processing unit 104, an application server 106, a database 108, a rating module 110, a text module 112, an audio module 114 and a video module 116 for collecting but not limited to ratings, reviews and feedbacks, and generating a visual score for end users. The system 100 comprises of the processing unit 104 which can access and process the rating collected from the rating module 110 in communication with the application server 106 in form of the text-based data derived from the text module 112, audio-based data from the audio module 114 that is the recorded feedback directly from user's speech, video recording data from the video module 116 that is the captured user's body language, facial expressions and other aspects of user's experience or combination thereof. Further, the processing unit 104 derive proper analytics in a way of saving user's' time and generates a multi-dimensional collective feedback based on the user input.

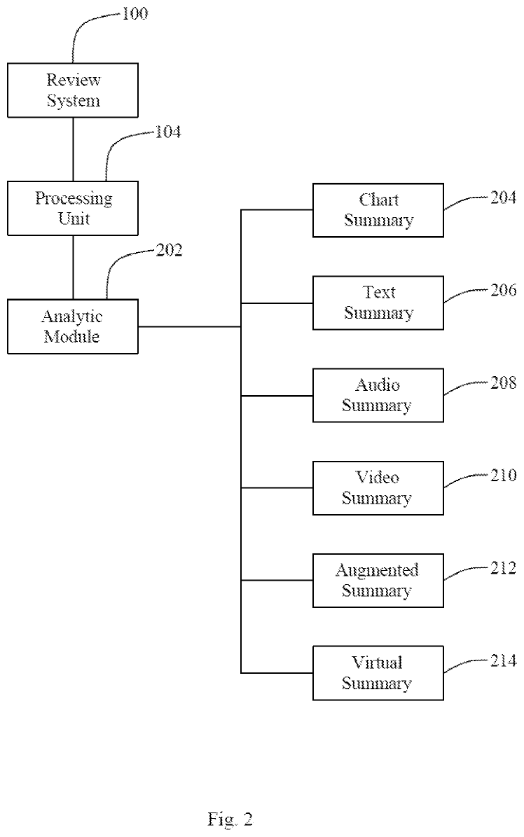

As discussed above, the system 100 derives the rating collected from users in different format such as but not limited to in the form of text-based data derived from the text module 112, audio-based data from the audio module 114 that is the recorded feedback directly from user's speech, video recording data from the video module 116 that is the captured user's body language, facial expressions and other aspects of user's experience or combination thereof. In an alternate embodiment of the present invention, the system 100 comprises of the processing unit 104 which can access and represents the rating into different formats by using an analytic module 202 as shown in FIG. 2. In some alternate embodiments, the ratings, reviews and feedbacks are presented as but not limited to a summary chart 204, a text summary 206, an audio summary 208, a video summary 210, an augmented summary 212 and a virtual summary 214.

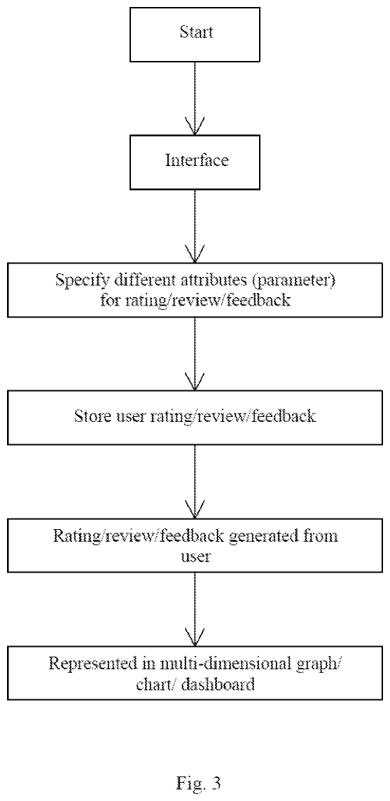

In one embodiment, as shown in FIG. 3, the system 100 includes a plug-in having the interface 102 for processing and generating the reviews, ratings, feedbacks using the rating module 110. On the interface 102, the rating module 110 is configured to enable the user to rate the different parameters also refereed as attributes of a product/services on any given scale. The present invention envisages that the user may be enabled to visually click or link the parameters (representing attributes of the product/service) one-by-one to desired rating scale. The user ratings are stored in the database 108 and all accumulated user ratings are generated as a score and also presented in form of multidimensional forms. After calculating the aggregated parameter scores across all the reviews, it can be desirable to display the parameters scores in a manner that would be useful to the users.

For each product/service being analyzed, a parameter set for the product/services is produced. The parameters will be the set of attributes for which the analysis will be done. There can be several manners in which a parameter set can be created. In some embodiments, the specifications can be analyzed, and the most important attributes mentioned in its specifications can be added to the parameter set. After calculating the various scores for each parameter, it can be desirable to display the scores to a user in a manner to allow a user to more accurately evaluate a product/service.

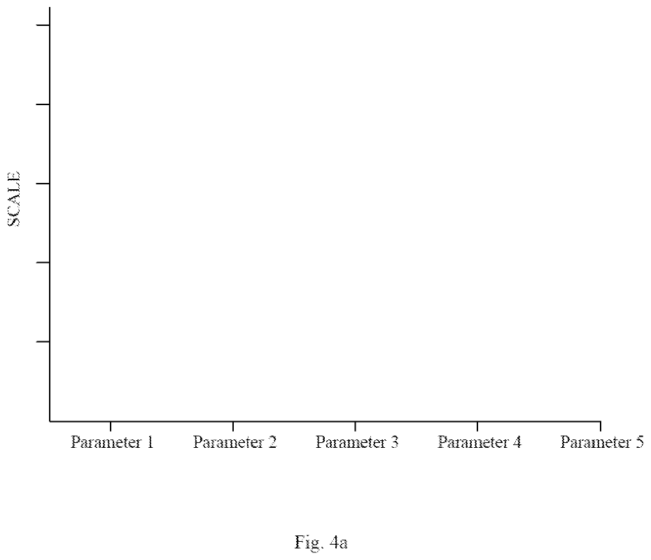

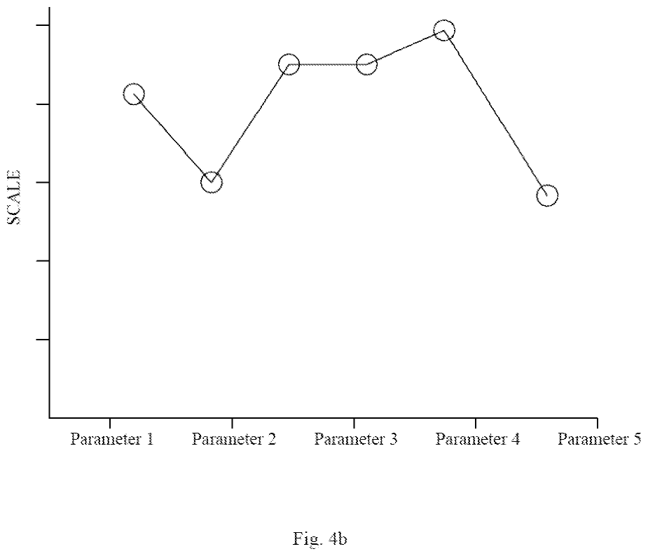

In one embodiment, the multidimensional form of rating means but not limed to a graph, a chart, a dashboard based on various key parameters. As shown in FIGS. 4a-4b, the user is presented with an interface on which the parameters are represented on the x-axis while the rating scale is represented on y-axis. The FIG. 4a represents the system 100 that can be created tailored to suit an entity/a provider and FIG. 4b represents the system 100 and the reviews, the ratings and the feedbacks are represented in a graphical format. The rating scale could be numerical, alphabetical or any other variable set. Particularly, the described embodiment of the present invention envisages that the user may drag or click the parameters from the x-axis and places it onto the desired rating on the rating scale, as shown in FIG. 4b. The user performs the same steps for each of the parameter such that all parameters have been placed on respective ratings on the rating scale, as shown in FIG. 4b.

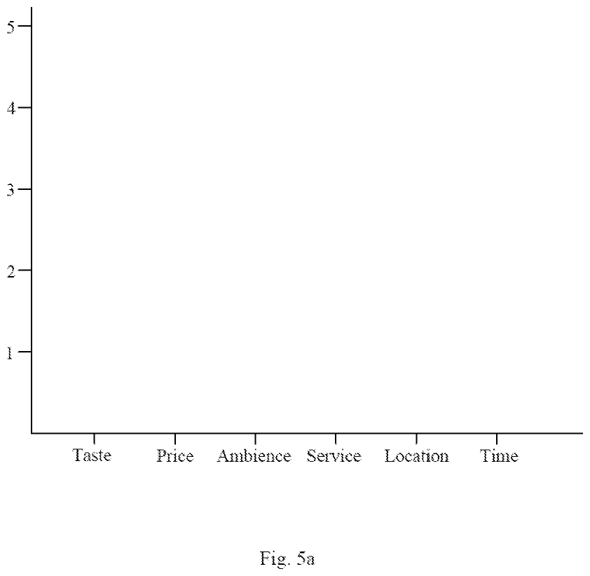

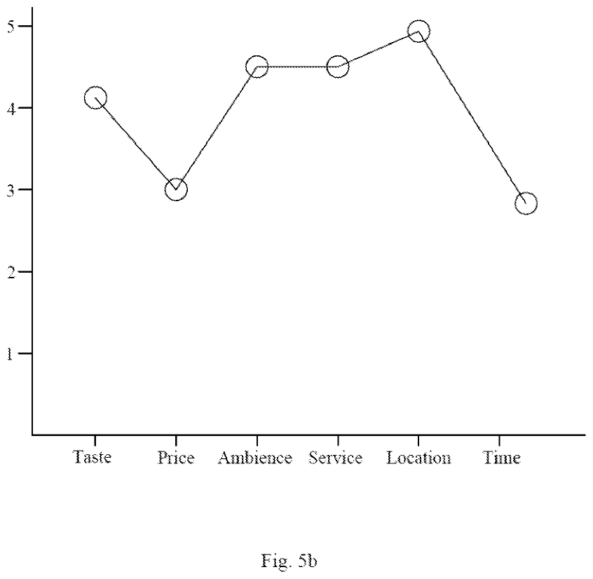

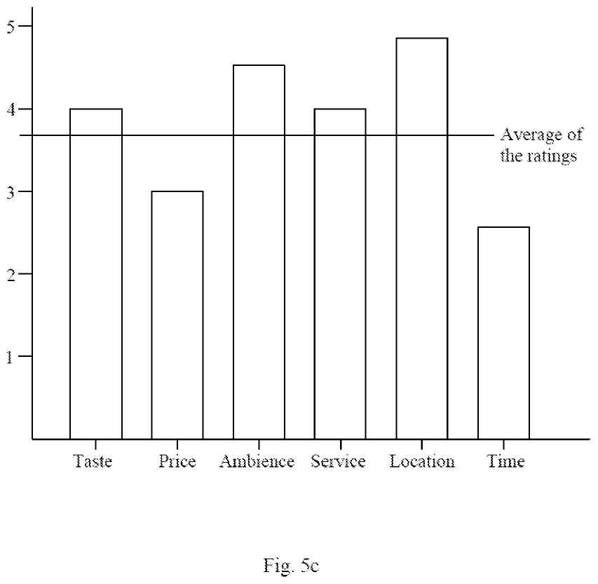

FIG. 5a shows an example of a system 100 using a computer-implemented interface 102 for rating a food and restaurant. In the interface 102, it is shown that on Y-axis is provided with point tally from 1,2,3,4 and 5 and on X-axis is provided with various parameters/features/keywords/attributes such as, but not limited to taste, price, ambience, service, location, time, etc. for rating purpose. The system 100 is configured to access and process the rating in form of the text-based data.

In some embodiments, the system is configured with a Natural Language Processing and Artificial intelligence server, for example when a customer visits a restaurant, he/she can give a feedback/review via a voice based application which is built on Language processing (example: Siri, Alexa, Cortana, Google Voice etc . . . ). The customer may speaks/records the following review in his natural language. The System may consider this natural language input and does Natural Language processing and applies artificial intelligence algorithms and provides the graphical representation of the feedback as shown in FIG. 3b and FIG. 3c and it also sets the overall rating for the restaurant.

FIG. 5b shows computed rating in form of a line received from the user and also provides star rating by computing all the various parameters. The system 100 provided is simpler than other systems that available in the art.

In one embodiment, the system 100 provides meaningful feedback, since the system 100 does not require a user to prepare a comment or answer a long series of questions in order to rate the product/service. The system uses simple graphical representation of various parameters for collecting rating, which minimizes the participation barrier that prevents users from providing ratings. As a result, more users will provide ratings. Further, the user can rate with or without registering and without reading any instructions. The system 100 also provides more tailored recommendations, making users more willing to rate the product/service.

FIG. 5c shows another example of a computed feedback in graphical form using a computer-implemented interface 102 for rating a food and restaurant. The ratings are provided as bar graph in form of a graphical representation received from the multiple users and also provide star rating by computing all the various parameters. In some embodiment, the system 100 aggregates multiple users' responses and shows the graphs in Multidimensional/Augmented/360-degree view charts. Further, the system 100 calculates and represents average of the reviews, the ratings and the feedbacks. The system 100 generates feedback automatically which enables new user to see previous rating into the system. Further, the user can rate product/service with or without registering and without reading any instructions. The system 100 also provides more tailored recommendations, making customers more willing to rate the product/service.

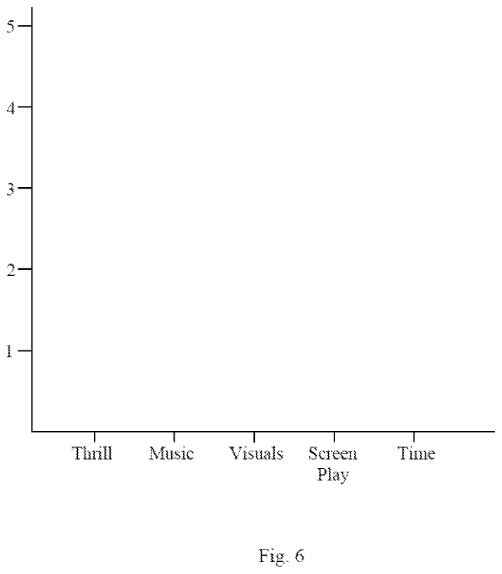

Similarly, FIG. 6 shows an example of a system 100 using a computer-implemented interface 102 for rating a movie. In the interface 102, it is shown that on Y-axis is provided with point tally from 1,2,3,4 and 5 and on X-axis is provided with various parameters/features/keywords/attributes such as, but not limited to thrill, visual, music, screen play, time, etc. for rating purpose.

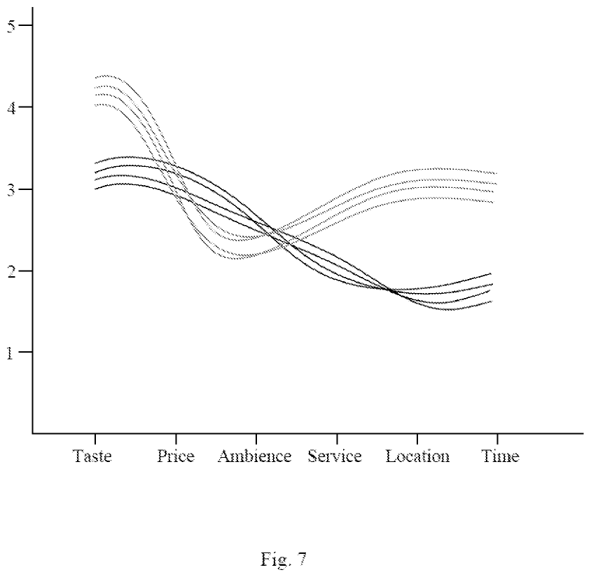

FIG. 7 shows another example of a system using a computer-implemented interface102 for rating and continuous multi-dimensional feedback generated by the system 100. The system 100 provides more meaningful feedback, because the content can be rated on a wide variety of parameter, enabling the system 100 to better predict which may be right for a user. This system is useful for meaningful rating for user and owners seeking to improve their services/product/facility/etc. Further, the feedback generated in substantially real-time enables service provider or product owner or facility, etc. a corrective action recommendation responsive to receiving hits on the set of parameters by the different service/product/facility users.

In similar manner, the system is being used for rating a product. In some embodiments, the parameters can be defined but not limited to Durability, Value, Quality, Delivery, Look & Feel etc.

As it is evident, the system 100 enables a single platform consolidated review wherein the respective ratings for all parameters are accessible. Thus, the system 100 enables the users to provide/rating/feedback/review on different attributes pertaining to a product/service, thereby enabling the users to holistically review a product/service. Consequently, the end-user is presented with pertinent information on a single platform without requiring him/her in a structured and discernible format.

In a preferred embodiment herein, the system 100 is adapted to collect reviews from the user based on different attributes/parameters. In yet another embodiment of the present invention, the parameters may be optionally prompted specific to the user. The system 100 is used to rate any attribute by the user in respect of any product/service on pre-defined parameters. Such parameters may be a numeric scale, alphabetical scale or a visual indicator such as emoticons. Each of the parameter represents a level of satisfaction experienced by the user for the attribute in consideration. The user visually links or clicks the attribute to the pre-defined parameter.

The system 100 disclosed herein provides an intelligent interface that may automatically add the most commonly used parameters for reviews. In yet another embodiment, the reviews so gathered from users are stored and may be processed and represented in form of charts, bar-diagrams or any other graphical representation. This is enabled by the rating module 108.

In another embodiment of the present invention provides the system 100 in which a review seeker, i.e. product/service provider, can create his own review system for a product or service under review. The said review system 100 is customizable to solicit reviews on selected parameters, representing attributes of the product/service to be reviewed, as required by the reviewer/review-seeker and presented to the end-users of the product/service.

In an alternate embodiment, the present invention provides free text based feedback using the system 100 without a restriction on parameters, user is entitled to enter any feedback. However, the system 100 will still be able to apply its inbuilt proprietary algorithms in understanding user's feedback and aggregate the results. The limitation with the Multi-dimensional feedback is that the dimensions are still pre-defined, and user has to select from the available set of parameters. They can't express freely on what their experience is, and the feedback is limited to what business wants to hear about. But majority of businesses might not be able to think upfront of these dimensions, so letting the users give a free text based feedback will always help if there is a system that can analyse these and derive meaningful analytics from these feedbacks.

For an example, after user had dinner at restaurant, he/she could give input in his own words, customer is free to write anything related to his/her experience. It's system's responsibility to derive a meaningful analysis from texts. While manually reviewing and deriving is a challenging task, having an intelligent AI system will always help in getting proper analytics.

In another alternative embodiment, the present invention further provides audio/speech based feedback. In the embodiment, the user can simply talk directly about their experience. The Voice intensity is captured to analyse the real gauge of intensity and the user's experience.

Further in another alternative embodiment, the present invention provides a system for capturing the feedback based on the facial expressions during their experience with the products/services without much of user's time. The limitation of Speech based feedback is customer's intervention is still required on talking his feedback. Many a times when user is giving feedback will be hesitant to give most appropriate feedback. However their body language, facial expressions and other aspects of customer's experience is taken care for capturing the feedback silently and get user's input. Further, the system can capture the face expressions when the consumer receives product and set the satisfaction on a specific parameter defined.

Additionally, the system is configured with Natural language based solution also allows users to search reviews directly via Alexa™, SIRI™, Cortana™ kind of applications

Further, in some embodiment, the system is configured with IOT (internet of Things) based Solution. The following should take the consent of the user before analysing the user and updating the feedback systems. The same parameters input can be received from different Internet of things like Wearables can analyse the consumers happiness quotient and set the feedback on the parameter.

In this way the embodiments herein envisage that from the same platform it is enabled to access ratings, reviews and feedback of products/services in a structured format. The present invention is beneficial for both the product/service providers and users at the same time. The present invention enables product/service providers to be continually aware of user experience and feedbacks from a single platform without requiring them to access unstructured information available across different online platforms. This also helps to gauge early market/user responses at the time of new product launch. Moreover, it enables business players to know about the acceptability of a product/service on offer, and therefore the brand value, of a company which is being acquired or entered into a joint venture. Besides, product/service providers can take strategic decisions since they are apprised of good and not so good experiences and have a clear visibility as to how the users are responding to their products/services on offer, and how they can improve the experience.

Therefore, the business entities can leverage this technology to get real-time attribute based feedbacks with real time analytics. Therefore, the integrated platform of the present invention serves the afore-said benefits which are missing from the existing state of the art.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A system for collecting and generating reviews, ratings and feedbacks from users, the system comprising:
an interface for collecting and generating the reviews, the ratings and the feedbacks;
the interface is configured with a rating module to provide the user with one or more parameters representing attributes of a product and/or service;
wherein the interface is configured to provide the reviews, the ratings and the feedbacks in form of but not limited to a chart summary, a text summary, an audio summary, and a video summary, an augmented summary and a virtual summary

2. The system of claim 1, wherein the system further comprises a text module to retrieve the reviews, the ratings and the feedbacks in form of a text.

3. The system of claim 1, wherein the system further comprises an audio module to retrieve the reviews, the ratings and the feedbacks in form of an audio-based that is the recorded directly from user's speech.

4. The system of claim 1, wherein the system further comprises a video module to retrieve the reviews, the ratings and the feedbacks in form of video recording data that is captured from user's body language and facial expressions or combination thereof.

5. The system of claim 1, wherein the reviews, the ratings and the feedbacks are further represented on the interface in form of but not limited to a multi-dimensional chart summary, a text summary, an audio summary, a video summary, an augmented summary and a virtual summary

6. The system as claimed in claim 5, wherein the interface is configured to provide the reviews, the ratings and the feedbacks in form of multi-dimensional configuration such as but not limited to a graph, a chart, a dashboard.

7. The system as claimed in claim 5, wherein the parameters representing attributes of a product and/or service is represented on X-axis.

8. The system as claimed in claim 5, wherein the reviews, the ratings and the feedbacks form the user is obtained on each parameter is represented by a numeric scale on Y-axis.

9. The system as claimed in claim 5, wherein the reviews, the ratings and the feedbacks are represented on the interface in form of but not limited to a line graph, a bar graph and a multi-dimensional graph

10. The system of claim 1, calculates and represents average of the reviews, the ratings and the feedbacks.

11. A method for collecting and generating reviews, ratings and feedbacks from users, the method comprising:
providing a user interface configured with a rating module to provide the user with one or more parameters representing attributes of a product and/or service;
receiving the reviews, the ratings and the feedbacks for each parameter by the user; and
displaying the reviews, the ratings and the feedbacks on the interface in form of but not limited to a chart summary, a text summary, an audio summary, a video summary, an augmented summary and a virtual summary.

12. The method of claim 11, wherein the user clicks and/or tabs and/or tags at least one parameter of the product and/or service.

13. The method of claim 11, wherein the method further comprises the reviews, the ratings and the feedbacks in form of a text.

14. The method of claim 11, wherein the method further comprises the reviews, the ratings and the feedbacks in form of an audio-based that is the recorded directly from user's speech.

15. The method of claim 11, wherein the method further comprises the reviews, the ratings and the feedbacks in form of video recording data that is captured from user's body language and facial expressions or combination thereof.

16. The method of claim 11, wherein the parameters representing attributes of a product and/or service is represented on X-axis.

17. The method of claim 11, wherein the reviews, the ratings and the feedbacks from the user is obtained on each parameter is represented by a numeric scale on Y-axis.

18. The method of claim 11, wherein the reviews, the ratings and the feedbacks are represented on the interface in form of but not limited to a line graph, a bar graph, a multi-dimensional graph

19. The method of claim 11, wherein the reviews, the ratings and the feedbacks are intelligently differentiated for each parameter based on the various parameters.

20. The method of claim 11, further calculates and represents average of the reviews, the ratings and the feedbacks.
